(19) United States
(12) Patent Application Publication
(10) Pub. No.: US 2009/0123182 A1
(43) Pub. Date: May 14, 2009

(54) IMAGE FORMING APPARATUS

(75) Inventors: Yoshihito SASAMOTO, Tokyo (JP); Hiroyuki WATANABE, Tokyo (JP); Tadayuki UEDA, Tokyo (JP); Ryuji OKUTOMI, Tokyo (JP); Akifumi ISOBE, Hidaka-shi (JP); Takashi NARA, Tokyo (JP); Jun ONISHI, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Konica Minolta Business Technologies, Inc., Tokyo (JP)

(21) Appl. No.: 12/262,356

(22) Filed: Oct. 31, 2008

(30) Foreign Application Priority Data
Nov. 9, 2007 (JP) 2007-292022

(51) Int. Cl. G03G 15/00

(52) U.S. Cl. 399/167

(57) ABSTRACT

An image forming apparatus including photoconductor drums corresponding to colors, motors, gears to transmit each rotation of the motors to each of the photoconductor drums, each of two gears comprising a portion to be detected intermittently continuing in a circumferential direction at a position having same radius centering around a rotary shaft of the gears, a pair of phase sensors to output detection signals of signal logics according to an existence or a non-existence of the portion to be detected at a point symmetric position centering around the rotary shaft of each of two gears and a control unit to calculate a rotation phase difference between each of the gears based on a logical combination of the detection signals which are output from the pair of phase sensors and to control the motors so as to synchronize rotation of each of the gears based on the calculated rotation phase difference.

### BACKGROUND OF THE INVENTION

1. Field of the Invention

The present invention relates to an image forming apparatus.

2. Description of Related Art

Conventionally, in an image forming apparatus such as an electrophotographic type color copier, an image forming is carried out by superimposing toner images of Y (yellow), M (magenta), C (cyan) and BK (black) onto one another. Particularly, in the image forming apparatus, the toner images of each of the colors are developed on the photoconductor drums (image supporting unit) of each of the colors, the toner images of each of the colors are transferred to an intermediate transferring unit which is a ring-shaped belt or the like so as to be superimposed in an order, and the transferred images are transferred to a recording medium (hereinafter, called “paper”) such as paper or the like to carry out the image forming.

Among the image forming apparatus which forms an image by the photoconductor drums of each color of Y, M, C and BK, there is an image forming apparatus which comprises a plurality of motors to rotationally drive each of the photoconductor drums. Each of the photoconductor drums for each color of the image forming apparatus is rotationally driven by any one of the drive system of the motors. Therefore, in the above image forming apparatus, there is a possibility that a color shift may occur when the image is being formed by orderly superimposing each color because the drive system which form each color are different. In order to prevent the color shift from occurring, there is a need to synchronize the rotation phase between the photoconductor drums of each color.

As for the technique to synchronize the rotation phase between the photoconductor drums of each color in the image forming apparatus, JP2005-196007 and JP2006-113200 are known. In JP2005-196007, there is disclosed a technique to prevent the color shift from occurring in the formed image by matching the phases between the rotary shafts of the photoreceptors when the photoreceptors are rotationally driven. Further, in JP2006-113200, there is disclosed a technique to detect the rotational standard position of each of the image supporting units and to control the drive of each of the image supporting units so that the each of the rotational standard positions which are detected match with one another or are proximate to one another.

The synchronization of the rotation phases between the photoconductor drums of each color is carried out when the drums are stopped or when the drums are being started-up. When the synchronization is carried out when the drums are stopped, there is no need to carry out an operation to match the rotation phases at the next start-up, and the start-up time can be shortened. However, when the drums are stopped, there is a need to slightly rotate the drums to prevent the drums from deteriorating by the drum blade at the time of non-imaging, and there was a case where the rotation phases which are synchronized before the drums are stopped are shifted at the time of start-up due to the difference of the inertia force of each of the drums.

Moreover, in the above prior art, there is a need to rotate the drums half-way according to their initial position in order to detect the rotation standard position of each of the drums when the rotation phases are to be synchronized at the time of start-up of the drums, and the start-up time could not be shortened. In order to shorten the start-up time, there is a need to separately provide the rotary encoder and the like for angle detection at each rotary shaft of each of the drums. However, there is a problem that an extra cost is needed when the rotary encoders are provided.

### SUMMARY OF THE INVENTION

An image forming apparatus reflecting one aspect of the present invention, comprises: a plurality of photoconductor drums corresponding to a plurality of colors, a plurality of motors, a plurality of gears to transmit each rotation of the motors to each of the plurality of photoconductor drums, each of at least two gears comprising a portion to be detected intermittently continuing in a circumferential direction at a position having same radius centering around a rotary shaft of the gears, a pair of phase sensors to output detection signals of signal logics according to an existence or a non-existence of the portion to be detected at a point symmetric position centering around the rotary shaft of each of at least two gears and a control unit to calculate a rotation phase difference between each of the gears based on a logical combination of the detection signals which are output from the pair of phase sensors and to control the motors so as to synchronize each rotation of each of the gears based on the calculated rotation phase difference.

Preferably, in the above image forming apparatus, a first region having an elongated portion to be detected continuing for a length worth of a central angle of 90 degrees and a second region not having the elongated portion to be detected for a length worth of a central angle of 90 degrees are formed in one of regions defined by a side end surface of each of at least two gears being divided in two in the circumferential direction, and a plurality of short portions to be detected which intermittently continue in the circumferential direction at positions in which the other of the regions is equally divided are formed in the other of the regions.

Preferably, in the above image forming apparatus, the portion to be detected is a rib in a convex form which is formed on a side end surface of each of at least two gears.

Preferably, in the above image forming apparatus, the portion to be detected is a slit or a groove which is formed on a side end surface of each of at least two gears.

Preferably, in the above image forming apparatus, the control unit controls a rotation speed of the motors based on the rotation phase difference.

Preferably, in the above image forming apparatus, the control unit synchronizes a rotation of each of the gears by driving the motor at a speed slower or equal to a rotation speed at an image forming.

Preferably, in the above image forming apparatus, each of the pair of phase sensors is a photosensor.

### BRIEF DESCRIPTION OF THE DRAWINGS

The present invention will become more fully understood from the detailed description given hereinbelow and the appended drawings, and thus are not intended as a definition of the limits of the present invention, and wherein:

FIG. 1 is a block diagram showing a structure of an image forming apparatus according to an embodiment of the present invention;

FIG. 2 is a schematic view showing a drive system of an image forming unit;

FIG. 3 is a block diagram showing a connection between motors and a control unit and a connection between phase sensors and the control unit;

FIG. 4 is an outer perspective view of proximity of a gear;

FIG. 5 is a schematic view showing an example of a rib-formed surface of the gear;

FIG. 6 is a table showing an example of determination of rotation positions based on the logical combination of detected signals; and

FIG. 7 is a flow chart showing an example of an operation of the image forming apparatus.

### DESCRIPTION OF THE PREFERRED EMBODIMENTS

Hereinafter, an embodiment of the present invention will be described with reference to the drawings. However, the present invention is not limited to the following embodiment. Further, the embodiment of the present invention describes the best mode for carrying out the present invention, and does not limit the scope of the invention.

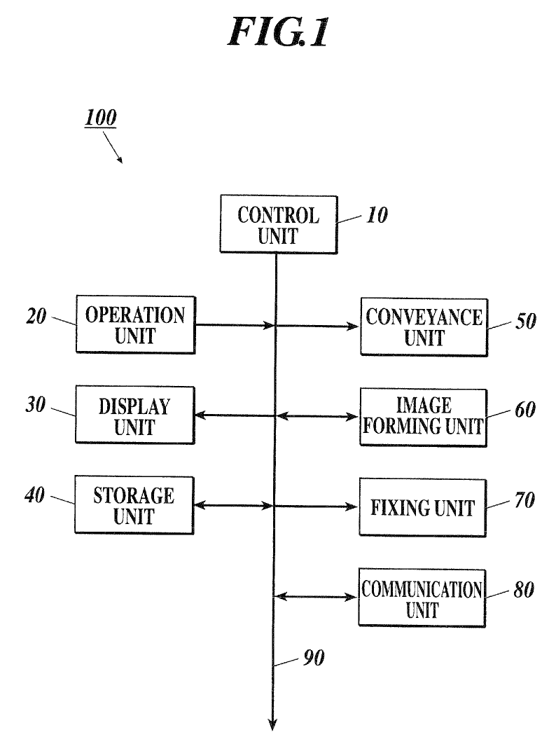

First, a structure of the image forming apparatus according to the embodiment will be described with reference to FIG. 1. FIG. 1 is a block diagram showing a structure of an image forming apparatus 100.

As shown in FIG. 1, the image forming apparatus 100 comprises a control unit 10, an operation unit 20, a display unit 30, a storage unit 40, a conveyance unit 50, an image forming unit 60, a fixing unit 70 and a communication unit 80. Each unit of the image forming apparatus 100 is connected to one another by a bus 90.

The control unit 10 comprises the CPU (Central Processing Unit), the ROM (Read Only Memory), the RAM (Random Access Memory) and the like. The control unit 10 integrally controls each unit (control unit). Particularly, the control unit 10 executes various types of processes by the CPU expanding the program data specified within various types of program data stored the ROM and cooperating with the program data expanded in the RAM.

The operation unit 20 is an operation key panel, a pressure-sensitive type (resistance film pressure type) touch panel in which the transparent electrodes are disposed in lattice on the screen of the display unit 30 (omitted from the drawing) or the like, and the operation unit 20 outputs the operation signal to be input to the control unit 10. The display unit 30 is the LCD (Liquid Crystal Display) or the like, and the display unit 30 displays an image based on the display control from the control unit 10.

The storage unit 40 is a non-volatile memory or the like such as magnetic memory, optical storage medium, semiconductor memory and the like. The storage unit 40 is structured so that the data from the control unit 10 can be written, and the storage unit 40 stores various types of control programs of the entire apparatus, setting information of the apparatus, data which is input from the communication unit 80 and the like.

Here, the storage unit 40 has an interface in which the storage medium such as the above mentioned magnetic memory, optical storage medium, semiconductor memory or the like is detachably mounted, and the storage unit 40 is structured so as to carry out the reading and writing of the data via the interface. In such case, the storage unit 40 reads the data which is stored in the mounted storage medium in advance, and the storage unit 40 can carry out the execution of various types of controls, the image forming in the image forming unit 60, the data transfer from the communication unit 80 to an external device and the like.

The conveyance unit 50 comprises a conveyance mechanism, a paper feeding tray, a paper election tray and the like (all of them are omitted from the drawing). The conveyance unit 50 conveys the paper stored in the paper feeding tray to the image forming unit 60 and ejects the paper in which an image is formed in the image forming unit 60 to the paper ejection tray under the control of the control unit 10.

The image forming unit 60 comprises an exposure unit, photoconductor drums of each color of Y (yellow), M (magenta), C (cyan) and BK (black), a developing unit, an intermediate transfer unit (for example, the intermediate transfer belt), a secondary transfer unit and the like. The image forming unit 60 forms multi colored images of Y, M, C and BK on the paper by the so-called electrophotographic method.

Particularly, the image forming unit 60 scans the photoconductor drums of each color by light exposure by the laser beam emitted from the exposure unit and forms an electrostatic latent image under the control of the control unit 10. Then, a toner image is formed by adsorbing the toner of each color corresponding to the photoconductor drums of each color by the developing unit. The toner image formed at the photoconductor drums of each color are transferred (primary transfer) to the intermediate transfer belt, and then are transferred (secondary transfer) to the paper which is to be conveyed by the conveyance unit 50 at the secondary transferring unit.

The fixing unit 70 comprises a fixing roller and a heater. The fixing unit 70 fixes the formed toner image on the paper by heat by pressing the fixing roller which is heated by a heater to the paper.

The communication unit 80 comprises a communication interface (omitted from the drawing) to connect with the communication circuit to carry out a communication with other information device and to connect with the network to which the other information device is connected. The communication unit 80 receives, for example, the image forming instruction and the like from other information device by carrying out the data communication by a predetermined communication protocol under the control of the control unit 10.

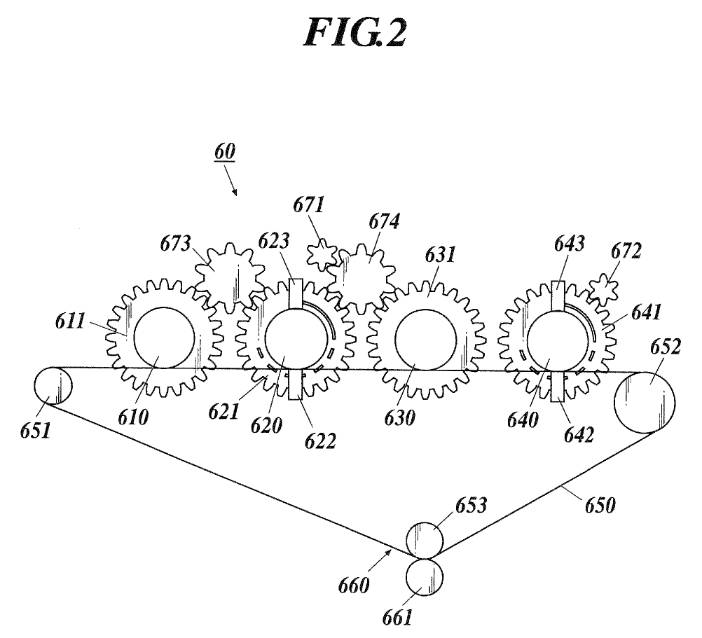

Next, the drive system of the image forming unit 60 will be described in detail with reference to FIG. 2. FIG. 2 is a schematic view showing the drive system of the image forming unit 60. As shown in FIG. 2, the drive system of the image forming unit 60 comprises the above mentioned photoconductor drums 610, 620, 630 and 640 of each color of Y, M, C and BK, the transfer belt 650, the secondary transfer unit 660 and the like.

Gears 611, 621, 631 and 641 for transmitting the driving force or the same drive shaft are provided at the photoconductor drums 610, 620, 630 and 640, respectively. That is, the rotation of each of the photoconductor drums 610, 620, 630 and 640 and the rotation of each of the gears 611, 612, 631 and 641 operate simultaneously with one another, respectively. That is, the simultaneous operation of each of the rotations can be carried out via an idler, a pulley or the like.

The gears 611, 621 and 631 are rotationally driven by operating simultaneously in advance by the idlers 673 and 674. The drive gear 671 which supplies driving force is connected to the idler 674. That is, the photoconductor drums 610, 620 and 630 for carrying out the image forming of each color of Y, M and C are rotationally driven so as to operate simultaneously to one another by the driving force supplied from the drive gear 671. The drive gear 672 which supplies driving force is connected to the gear 641. That is, the photoconductor drum 640 for carrying out the image forming of the color BK is rotationally driven by the driving force supplied by the drive gear 672.

The drive gears 671 and 672 for supplying driving force to the gears 611, 621, 631 and 641 are connected to a motor (drive motor) different from one another. That is, the motor which drives the photoconductor drums 610, 620 and 630 of each color of Y, M and C and the motor which drives the photoconductor drum 640 of the color BK are different from one another.

At the gear 621 which operates simultaneously with the photoconductor drums 610, 620 and 630 of each color of Y, M and C, a rib which is a portion to be detected that continues in a circumferential direction is formed on the circumference having the same radius centering around the rotary shaft on the surface (side end surface) orthogonal to the rotary shaft (the detail will be described afterward). Just above the circumference on which the rib of the gear 621 is formed, the phase sensors 622 and 623 are provided at the point symmetric position centering around the rotary shaft. At this disposed position, the phase sensors 622 and 623 outputs the detection signal based on the rib which passes right below by the rotation of the gear 621. For the phase sensors 622 and 623, for example, a photosensor, an ultrasonic sensor or the like can be used.

In similar manner, at the gear 641 which simultaneously operates with the photoconductor drum 640 of the color BK, a rib which is a portion to be detected which continues in the circumferential direction is formed on the circumference having the same radius centering around the rotary shaft on the surface (side end surface) orthogonal to the rotary shaft. Further, the phase sensors 642 and 643 are provided at the symmetric position centering around the rotary shaft just above the circumference.

The transfer belt 650 is driven by being supported with the belt drive shafts 651, 652 and 653. The toner images formed on the each photoconductor drum are primarily transferred to the transfer belt 650 by the photoconductor drums 610, 620, 630 and 640 which contact with the transfer belt 650 within the range being supported by the belt drive shafts 651, 652 and 653. The secondary transfer unit 660 comprises the transfer roller 661 which presses the paper to the transfer belt 650 supported by the belt drive shaft 653. At the secondary transfer unit 660, the secondary transfer is carried out to the paper by pressing the paper to the transfer belt 650 on which the toner images are primarily transferred.

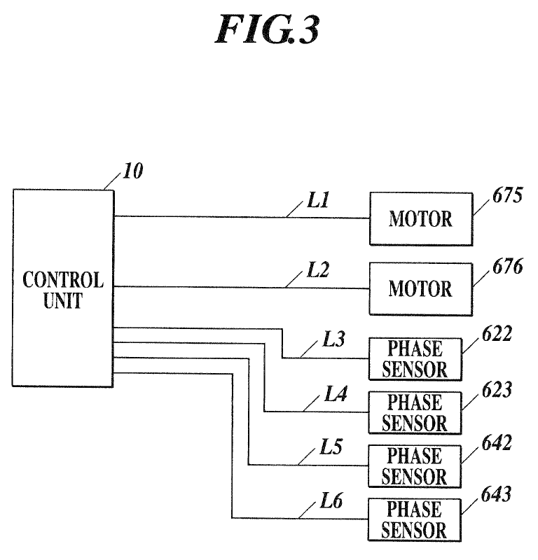

Here, the connection between the motors and the control unit 10 and the connection between the phase sensors and the control unit 10 in the drive system of the above described image forming unit 60 will be described with reference to FIG. 3. FIG. 3 is a block diagram showing the connection between the motors and the control unit 10 and the connection between the phase sensors and the control unit 10 in the drive system of the image forming unit 60.

As shown in FIG. 3, the motors 675 and 676 which supply driving force to the drive gears 671 and 672 are connected with the control unit 10 by the signal wires L1 and L2, respectively. The control unit 10 controls the motors 675 and 676 individually by outputting the control signal such as the PWM (Pulse Width Modulation) signal and the like to each of the motors via the signal lines L1 and L2.

Moreover, the phase sensors 622, 623, 642 and 643 to detect the rotation phase of the gears 621 and 641 are connected with the control unit 10 by the signal lines L3, L4, L5 and L6, respectively. The control unit 10 receives detection signals from each of the phase sensors via the signal lines L3, L4, L5 and L6.

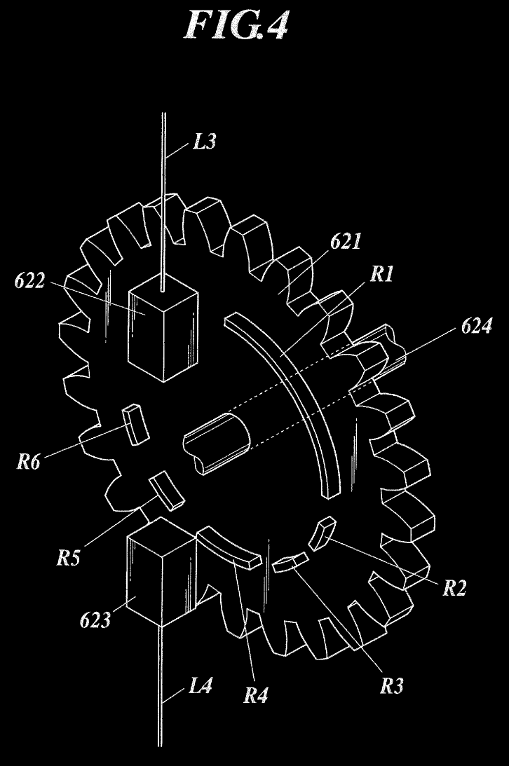

Here, the detail of the gears 621 and 641 on which ribs are formed will be described with reference to FIG. 4. FIG. 4 is an outer perspective view showing proximity of the gear 621. Here, because the patterns formed on the gears 621 and 641 are the same, therefore the gear 621 will be described as an example in the following description.

As shown in FIG. 4, the gear 621 is driven by using the drive shaft 624 which is connected with the above photoconductor drum 620 as the rotary shaft. At the side end surface of the gear 621, ribs R1 to F6 are formed on the circumference having same radius from the rotary shaft. The ribs R1 to R6 are integrally molded with the gear 621 at the time of manufacturing and are formed in a convex form on the side end surface of the gear 621. At a position just above the circumference where the ribs R1 to R6 are formed, the phase sensors 622 and 623 are disposed at a point symmetric position centering around the rotary shaft.

In the image forming apparatus 100, the ribs R1 to R6 formed on the gear 621 are integrally molded at the time of manufacturing. Therefore, the manufacturing cost can be reduced comparing to the case where the rotary encoder or the like which simultaneously operates with the gear 621 is provided.

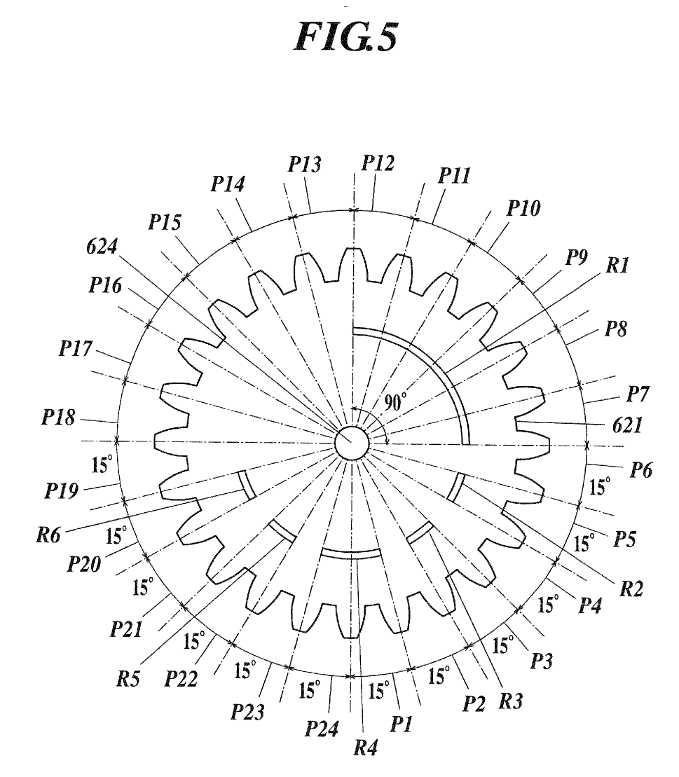

Here, the forming position of the ribs on the same radius centering around the rotary shaft of the gear 621 will be described with reference to FIG. 5 which shows the surface of the gear 621 on which the ribs are formed as an example. Here, the circumferential positions P1 to P24 shown in FIG. 5 are set by dividing the circumference centering around the drive shaft 624 of the gear 621 in twenty four portions by the central angle of 15 degrees.

As shown in FIG. 5, the rib R1 (the first region) is formed on the portion of circumference covering the circumferential positions P7 to P12 having a central angle of 90 degrees on the surface of the gear 621 where the ribs are formed. Here, the ribs are not formed in the region covering the circumferential positions P13 to P18 continuing from the circumferential position P12 (the second region). Thus, in the half circle (one of the regions) covering the circumferential positions P7 to P18, the one forth portion (central angle of 90°) of the circumference can be recognized by the rib R1.

In the other half circle (the other of the regions) which is the counter part of the above described portion covering the circumferential positions P7 to P18, the ribs R4, R3 and R2 are formed at the circumferential positions P1, P3 and PS within the portion covering circumferential positions P1 to P6 which is symmetrical to the portion covering circumferential positions P13 to P18 centering around the rotary shaft. Moreover, within the portion covering circumferential positions P19 to P24 which is symmetrical to the portion covering circumferential positions P7 to P12 centering around the rotary shaft, the ribs R6, R5 and R4 are formed at the circumferential positions P20, P22 and P24. The ribs which are formed at the portion covering circumferential positions P1 to P6 and the ribs which are formed at the position covering circumferential positions P19 to P24 are the mirror-image symmetry wherein the surface which divides the circumferential position P1 and the circumferential position P24 being the mirror plane. Thus, the circumferential position in which the one forth of the circumference recognizable by the rib R1 is further divided in four can be recognized by the rib disposed by the central angle of 15 degrees in the other half circle which is the counterpart of the half circle covering the circumferential positions P7 to P18.

In the image forming apparatus 100, the ribs are detected by each of the phase sensors provided at the symmetric position centering around the rotary shaft on the surface of the above described gear 621 on which the ribs are formed. Therefore, the detection of the rotation phase (rotational position) of the gear 621 can be carried out in the rotation angle of less than 90 degrees based on the logical combination (change in time) of the detected signal which is output along with the rotation of the gear 621 from each of the phase sensors.

In particular, a case where one of the phase sensors is positioned at the circumferential position P1 and the other of the phase sensors is positioned at the circumferential position P13 will be described as an example. The detection signal (1: rib exists, 0: rib does not exist) in such case is (10) when the signal corresponds to (the detection signal of one of the phase sensors, the detection signal of the other of the phase sensors). When the detection is orderly carried out in a counter clock wise direction from this position, the logical combination of the detection signals output from each of the phase sensors along with the rotation of the gear 621 in the clock wise direction is (10, 00, 10, 00, 10, 00, 10, 11, 10, 11, 10, 11, 01, 00, 01, 00, 01, 00, 01, 11, 01, 11, 01, 11).

When the detection of the rotation phase is started from the state where the one of the phase sensors is at the circumferential position P1, the rotation phase is decided at the time when the logical combination of the detection signals when the detection of the rotation phase is started from the state where the one of the phase sensors is at the circumferential position P1 differ from the logical combination of the detection signals when the detection is started from the state where one of the phase sensors is at another circumferential position.

The logical combination of the detected signals is (10, 00, 10, 00, 10, 00 . . . ) when the detection is started from the circumferential position P1, and the case that matches with this logical combination for the longest is the case where the detection is started from the circumferential position P3. When the detection is started from the circumferential position P3, the logical combination is (10, 00, 10, 00, 10, 11 . . . ) Therefore, when the detection is started from the circumferential position P1, the rotation phase is decided at the circumferential position P6. In a similar manner, when the detection is started from the circumferential position P3, the rotation phase is decided at the circumferential position P8. Here, the circumferential position where the rotation phase is decided is also determined in a similar way even when the detection is started from other circumferential positions.

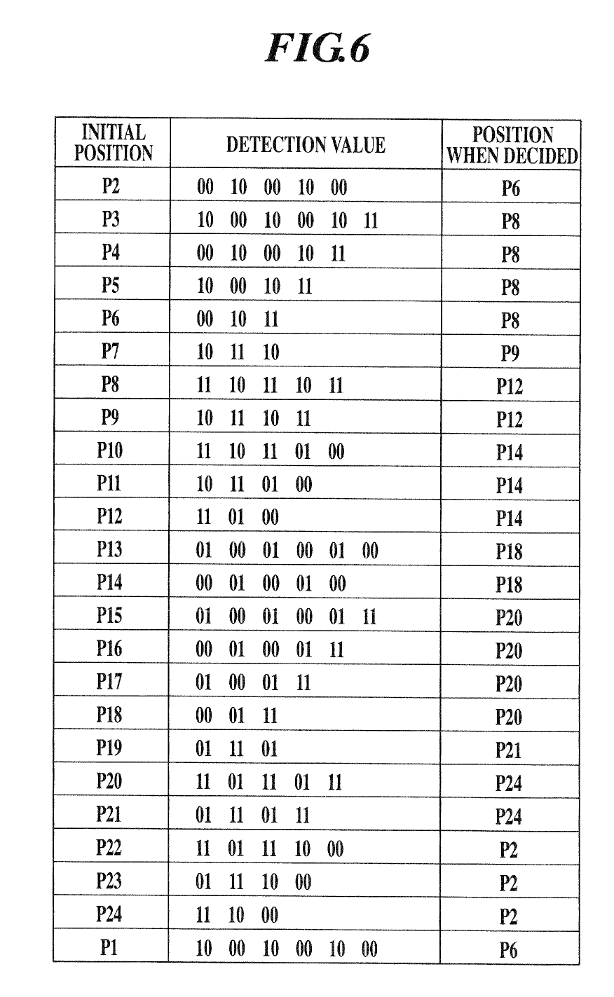

FIG. 6 is a table in which the deciding of the rotation positions based on the above described logical combination of the detection signals is organized. In the image forming apparatus 100, the ribs of the above gear 621 are detected by each of the phase sensors provided at a symmetric position centering around the rotation shaft. Therefore, the logical combination of the detection signals is decided in the rotation angle of less than 90 degrees as shown in FIG. 6. The image forming apparatus 100 stores the data which shows the corresponding relation between the logical combination of the detection signals and the rotation position in the ROM of the control unit 10 or in the storage unit 40 in advance. In the control unit 10, the rotation phase of the gear 621 can be calculated by referring to the above described corresponding data based on the detection signals from each of the phase sensors.

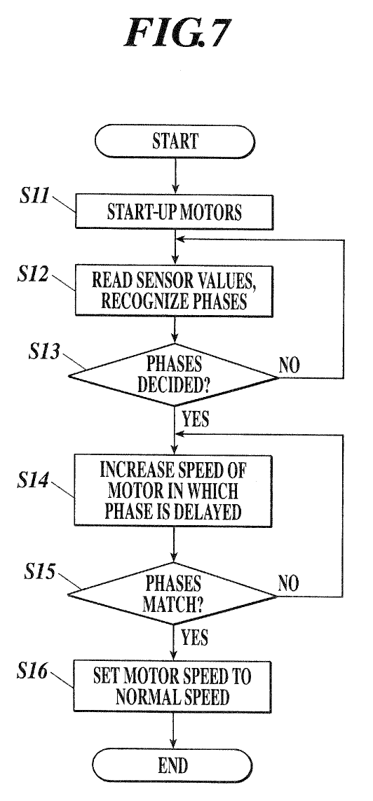

Next, the operation of the image forming apparatus 100 which is executed under the control of the control unit 10 will be described in detail with reference to FIG. 7. FIG. 7 is a flowchart exemplifying the operation of the image forming apparatus 100.

As shown in FIG. 7, when the process is started, the control signal is output to the motors 675 and 676 from the control unit 10 to start-up each of the motors (step S11). In step S11, the control signal is output so that the motors 675 and 676 are driven at the driving speed slower or equal to the driving speed (for example, half the driving speed at the time of image forming) of the motors at the time of image forming.

Next, the sensor values (detection signals) from each of the phase sensors are read, and the rotation phase of each of the gears is recognized until it is determined that the rotation phase of each of the gears are decided based on the sensor values and the above described corresponding data (steps S12, S13). That is, in steps S12 and S13, the rotation phase of the photoconductor drums 610, 620 and 630 which rotate simultaneously with the gear 621 and the photoconductor drum 640 which rotates simultaneously with the gear 641 are recognized.

Next, the adjustment of the rotation phase is carried out until the rotation phases of each of the gears match by adjusting the driving speed of either one of the motors by carrying out the feed back control based on the rotation phases of each of the gears which are recognized in steps S12 and S13. For example, the driving speed of the motor of the gear in which the rotation phase is delayed is increased (step S14), and the adjustment of the rotation phase is carried out until the rotation phases of each of the gears match with one another (step S15). Subsequently, the driving speed of the motors 675 and 676 is set so as to be at the normal speed after the rotation phases of each of the gears are matched with one another (step S16) and the process is finished.

Here, in the feedback control in steps S14 and S15, the difference of the rotation phases of each of the gears is calculated and the driving speed of either one of the motors may be adjusted based on the calculated phase difference. For example, when the phase difference is large, the adjusting amount of the driving speed may be larger. Further, when the phase difference is small, the adjusting amount of the driving speed may be smaller. In such way, the rotation phases can be made to match in a shorter time even when the phase difference is large by adjusting the driving speed based on the difference of the rotation phases of each of the gears. Further, overshoot can be prevented from occurring when the phase difference is small.

As described above, the image forming apparatus 100 comprises the gears which rotate simultaneously with each of the photoconductor drums in which the driving source is different from one another. Further, in the image forming apparatus 100, the portions to be detected which continue in the circumferential direction at the position having the same radius centering around the rotary shaft are formed on the side end surface of the gears. Furthermore, a pair of sensors to output the detection signals of the signal logic according to the existence or non-existence of the portion to be detected in the point symmetric position centering around the rotary shaft of each of the above gears is provided at the image forming apparatus 100, and the image forming apparatus 100 is structured so as to calculate the rotation phase of each of the gears based on the logical combination of the detection signals of the sensors and so as to comprise the control unit (control unit 10) which carries out the control of the driving source based on the calculated rotation phase of each of the gears.

Therefore, as for the image forming apparatus 100, the portions to be detected which continue in the circumferential direction at the position having the same radius centering around the rotary shaft are provided in the image forming apparatus which forms a multi color image on the paper by superimposing the color images formed by a plurality of photoconductor drums. Further, regarding the gears which communicate the rotation of the drive motors to the photoconductor drums, the rotation phase difference between each of the gears is calculated based on the logical combination of the detection signals of a pair of sensors which outputs the detection signals of the signal logic according to the existence or non-existence of the portions to be detected at the point symmetric position centering around the rotary shaft of the gear and the rotation of each of the gears can be synchronized based on the calculated rotation phase difference.

Therefore, in the image forming apparatus 100, the rotation phases of each of the photoconductor drums can be synchronized by detecting the rotation condition of the photoconductor drums in shorter time comparing to the case where the rotation standard position is to be detected. Further, in the image forming apparatus 100, the cost for providing the rotary encoder or the like is saved and the synchronizing of the rotation phase of each of the photoconductor drums by detecting the rotation condition of the photoconductor drums can be carried out at a lower cost.

Here, the above description of the embodiment shows an example, and the present invention is not limited to this. The structure and the operation in the above described embodiment can be arbitrarily modified.

For example, in the above description, an example where the ROM is used as a computer readable medium of the program according to the present invention is disclosed. However, the present invention is not limited to this example. A non-volatile memory such as the flash memory and a transportable recording medium such as the CD-ROM can be used as other computer readable medium. Further, the carrier wave is also used in the present invention as a medium to provide the data of the program according to the present invention via the communication circuit.

Moreover, in the above description, an example in which the portions to be detected in each of the gears are the ribs which rises in the convex form on the surface of the gears is disclosed. However, the present invention is not limited to this example. For example, the pattern on each of the gears for detecting the rotation phases may be slits or grooves formed in a concaved form on the surface of the gears. Further, this pattern may be formed with a different material which can be detected by the sensors other than to be formed in a pattern in a shape such as concave or convex. For example, the image forming apparatus 100 may be structured so as to form the pattern of the gear by the existence or non-existence of magnetic body and to detect the magnetic body by the magnetic sensor.

Moreover, in the above description, regarding the form of ribs in the gears 621 and 641, a structure in which the circumferential position is recognized by the portion worth of one fourth which is recognized in half of the circumference being further equally divided in four by the ribs which are positioned in the other half of the circumference by central angle of 15 degrees is exemplified. However, the present invention is not limited to this example. For example, a structure in which the circumferential position is recognized by further dividing the rib formed along one forth of the circumference which is recognized in the half of the circumference into halves by the ribs positioned within the other half of the circumference by a central angle of 30 degrees can be applied. Further, a structure in which the circumferential position is recognized by further dividing the rib formed along one forth of the circumference which is recognized in the half of the circumference equally into six by the ribs positioned within the other half of the circumference by a central angle of 10 degrees can be applied. In particular, in the image forming apparatus 100, the detection accuracy of the rotation phase of each of the gears can be improved by increasing the division number. However, the division number can be any number as long as the number is within the acceptable range of color shift in each of the photoconductor drums which rotate simultaneously with each of the gears.

The present U.S. patent application claims a priority under the Paris Convention of Japanese paten application No. 2007-292022 filed on Nov. 9, 2007, which shall be a basis of correction of an incorrect translation.

What is claimed is:

1. An image forming apparatus, comprising:
a plurality of photoconductor drums corresponding to a plurality of colors;
a plurality of motors;
a plurality of gears to transmit each rotation of the motors to each of the plurality of photoconductor drums, each of at least two gears comprising a portion to be detected intermittently continuing in a circumferential direction at a position having same radius centering around a rotary shaft of the gears;
a pair of phase sensors to output detection signals of signal logics according to an existence or a non-existence of the portion to be detected at a point symmetric position centering around the rotary shaft of each of at least two gears; and
a control unit to calculate a rotation phase difference between each of the gears based on a logical combination of the detection signals which are output from the pair of phase sensors and to control the motors so as to synchronize each rotation of each of the gears based on the calculated rotation phase difference.

2. The image forming apparatus of claim 1, wherein
a first region having an elongated portion to be detected continuing for a length worth of a central angle of 90 degrees and a second region not having the elongated portion to be detected for a length worth of a central angle of 90 degrees are formed in one of regions defined by a side end surface of each of at least two gears being divided in two in the circumferential direction, and
a plurality of short portions to be detected which intermittently continue in the circumferential direction at positions in which the other of the regions is equally divided are formed in the other of the regions.

3. The image forming apparatus of claim 1, wherein the portion to be detected is a rib in a convex form which is formed on a side end surface of each of at least two gears.

4. The image forming apparatus of claim 1, wherein the portion to be detected is a slit or a groove which is formed on a side end surface of each of at least two gears.

5. The image forming apparatus of claim 1, wherein the control unit controls a rotation speed of the motors based on the rotation phase difference.

6. The image forming apparatus of claim 1, wherein the control unit synchronizes a rotation of each of the gears by driving the motor at a speed slower or equal to a rotation speed at an image forming.

7. The image forming apparatus of claim 1, wherein each of the pair of phase sensors is a photosensor.
